(19) United States
(12) Patent Application Publication
(10) Pub. No.: US 2004/0107022 A1
(43) Pub. Date: Jun. 3, 2004

(54) Method and apparatus for automatic capture of label information contained in a printer command file and for automatic supply of this information to a tablet dispensing/counting system

(76) Inventor: Michael R. Gomez, Stamford, CT (US)

Correspondence Address: Gordon & Jacobson, P.C., 65 Woods End Road, Stamford, CT, 06905, US

(21) Appl. No.: 10/307,824

(22) Filed: Dec. 2, 2002

(51) Int. Cl. G06F 17/00; G06F 15/00; G07F 11/00; G06F 7/00; G06F 15/02; G06F 3/12; G06F 13/00

(52) U.S. Cl. 700/231; 358/1.18; 221/9; 235/425; 235/432

(57) ABSTRACT

An interface unit is operably coupled between a pharmacy management computing subsystem and printer, and is operably coupled between the pharmacy management computing subsystem and a tablet counting/dispensing subsystem. In response to a user issuing a command to print a prescription label, a printer command file is generated by a label print function of the pharmacy management computing subsystem. The printer command file is supplied to the interface unit, where it is processed to render and store a bit map image of the prescription label. Symbol recognition operations are performed on portions of the bit map image to generate a sequence of symbol identifier values (e.g., an alphanumeric character string) that corresponds to symbols identified in such portions. This sequence of symbol identifiers represents information pertaining to the prescription, such as (such as NDC number, prescription number, drug name and strength, count (quantity-to-be-dispensed), patient instructions (SIG code), patient name, price, etc). It is used to build a data message that is communicated to the tablet counting/dispensing subsystem, which stored and accesses this data to assist in tablet counting operations and/or tablet dispensing operations performed therein. In addition, the label processing operations of the interface unit is preferably configured during a set up routine which enable the end user to specify locations of portions of a sample label bit map image that correspond to relevant data fields. Such locations are stored in persistent storage and used in subsequent label processing operations to capture the relevant information contained in the label.

### BACKGROUND OF THE INVENTION

1. Field of the Invention

This invention relates to pharmacy information management systems for managing the dispensing of pharmaceutical drugs and other medicaments in accordance with prescriptions issued by doctors. This invention more particularly relates to pharmacy information management systems that interface to tablet counters and automatic tablet dispensing stations which count and/or dispense tablets.

2. State of the Art

Modern pharmacies typically include a pharmacy management computer system that maintains a database of information that generally includes customers, doctors and other health care providers, prescriptions to be filled, prescription that have been filled, etc. In addition, the management computer system typically includes features that enable efficient processing of prescriptions, such as

the ability to refill prescriptions for a given customer with just a few keystrokes or mouse clicks;

the ability to set up refill control for state requirements;

the ability to screen prescriptions against customer records for duplicate prescriptions, drug-disease conflicts, allergies, and patient compliance based on timeliness of refills;

the ability to link codes and free text to quickly produce detailed directions;

the ability to write unlimited notes regarding patients, doctors, drugs, and prescriptions;

the integration of or linking to subsystems that provide for electronic submission of claims/billing;

the integration of or linking to subsystems that provide for inventory management and price quotes; and

the integration of or linking to subsystems that provide for accounts receivable management.

The pharmacy management computer system also includes a label print function that generates a printer command file in response to a user requesting that a given prescription label be printed. This printer command file is supplied to a printer, which processes the file and prints the prescription label. The prescription label is typically organized as a two dimensional array of data fields that stores information including a patient name, prescription number, drug name and strength, quantity to be dispensed, patient instructions, doctor name, price paid by patient, etc. as illustrated in the exemplary prescription label shown in FIG. 1.

In the United States, the drug name and strength is identified by a unique 10 digit code known as the National Drug Code (NDC). Equivalent codes are used in other countries. The 10-digit NDC code includes subgroups of digits that provide the details for product, strength, form and pack size as well as the name of the manufacturer. Unfortunately, there is no standard arrangement of subgroups within the NDC code and there are variations used by different manufacturers. Moreover, non-pharmaceutical products are identified by an eleven digit code which is derived by adding a zero the NDC code. Because of the variations in arrangement of subgroups within the NDC code, the zero is placed at different positions in the NDC code.

In addition, modern pharmacies typically include tablet counters and/or automatic tablet dispensing systems (collectively referred to herein as “automatic tablet counting/dispensing systems” or “automatic tablet counting/dispensing subsystems”) to assist the pharmacy in filling prescriptions. For purposes of brevity, reference to “tablets” should be understood herein as being generic to tablets, capsules, caplets and any other solid dose medication.

Generally, there are three types of tablet counters available for dispensing prescription medication from bulk containers of such medications: a preset counter, a pour-through counter and a cassette counter. A description of these three types of tablet counters is described in U.S. patent application Ser. No. 09/871,532, filed on May 31, 2001, commonly owned by assignee of the present invention and incorporated by reference in its entirety.

Automatic tablet dispensing systems are generally robotic-based systems that count and dispense tablets from prefilled cassettes into containers. In addition, such systems may automatically print and apply the prescription label (and possibly other labels) on the container and deliver the containers for final inspection. An exemplary automatic tablet dispensing system is described in detail in Williams et al., U.S. Pat. No. 6,036,812, incorporated by reference in its entirety.

In order to limit data entry (and associated operator error) in the counting/dispensing operations performed by the automatic tablet counting/dispensing systems, solutions have been developed that enable information pertaining to a prescription (such as prescription number, drug name and strength, quantity to be dispensed, patient instructions, patient's name, etc) to be communicated between the pharmacy management computing system and the automatic tablet counting/dispensing system. Generally, the drug name and strength is used to verify that the correct bulk container is selected, and quantity-to-be-dispensed is used during counting operations to dispense the correct number of tablets. In addition, automatic tablet dispensing systems typically utilize the information pertaining to the prescription when automatically printing and affixing a prescription label to a container.

The pharmacy management computing system typically interfaces to an automatic tablet counting/dispensing system through an application programming interface (API) internal to both the pharmacy management computing system and the automatic tablet counting/dispensing system. Such an interface is complex and requires expert knowledge of the internal structures of the respective systems in order to adapt the systems to cooperate with one another. Such complexities make the design, setup and maintenance of the internal interface costly to the solutions provider and to the pharmacy.

In addition, the interfaces are typically “hidden” and accessible only by experts that design and maintain the interface. In such systems, cooperation is required between the party that designs the pharmacy management computing system and the party that designs automatic tablet counting/dispensing system in order to adapt the systems to cooperate with one another. Such cooperation may be unattainable if the two parties cannot agree on business terms and also makes the design, setup and maintenance of the internal interface costly to the solutions provider and to the pharmacy.

Thus, there is a great need in the art for a simple and efficient mechanism that enables a pharmacy management computing system to interface to automatic tablet counting/dispensing systems such that information pertaining to a prescription (such as prescription number, drug name and strength, quantity-to-be-dispensed, patient instructions, patient's name, etc) can be communicated from the pharmacy management computing system to the automatic tablet counting/dispensing system.

### SUMMARY OF THE INVENTION

It is therefore an object of the invention to provide a data interface that captures relevant information generated by the pharmacy management computing system and communicates such information to the automatic tablet counting/dispensing subsystem.

It is an additional object of the invention to provide a data interface that captures relevant information generated by the pharmacy management computing system without adaptation or modification of the pharmacy management computing system.

It is a further object of the invention to provide an interface which processes the print data stream generated by the pharmacy management computing system to capture relevant information and supply such information to the automatic tablet counting/dispensing subsystem.

It is a yet another object of the invention to provide a data interface that captures relevant information generated by a broad variety of pharmacy management computing systems and communicate such information to the automatic tablet counting/dispensing subsystem.

In accord with these objects, which will be discussed in detail below, an interface unit is operably coupled between a pharmacy management computing subsystem and printer. In addition, the interface unit is operably coupled between the pharmacy management computing subsystem and a tablet counting/dispensing subsystem. In response to a user issuing a command to print a prescription label, a printer command file is generated by a label print function of the pharmacy management computing subsystem. The printer command file is supplied to the interface unit, which stores this printer command file and preferably forwards it to the printer. In addition, the interface unit processes the printer command file to render and store a bit map image of the prescription label, and performs symbol recognition operations on portions of the bit map image to generate a sequence of symbol identifier values (e.g., an alphanumeric character string) that corresponds to symbols identified in such portions. This sequence of symbol identifiers represents information pertaining to the prescription, such as prescription number, drug name and strength, quantity-to be-dispensed, patient instructions, patient's name, etc. It is used to build a data message that is communicated to the tablet counting/dispensing subsystem. The tablet counting/dispensing subsystem extracts and stores the data in this data message, and accesses this stored data to assist in tablet counting operations and/or tablet dispensing operations performed therein.

The bit map image of the prescription label generated by the interface unit may be updated (for example, by adding information to the bit map image, by changing the font and/or layout of the bit map image), and this updated bit map image is converted to a printer command file representing the updated bit map image. Alternatively, updates may be made to the printer command file such that it represents an updated prescription label. In either case, the printer command file representing the updated prescription label is forwarded to the printer where the updated prescription label is printed.

In addition, the label processing operations of the interface unit is preferably configured during a setup routine performed by the end user such that the interface unit captures the relevant information for the specific label format utilized by the pharmacy management computer subsystem. Such setup operations enable the end user to specify the locations of portions of a sample label bit map image that correspond to relevant data fields (such as prescription number, drug name and strength, quantity-to-be-dispensed, patient instructions, patient name, etc). Such locations are stored in persistent storage and used in subsequent label processing operations to capture the relevant information contained in the label, and supply it to the tablet counting/dispensing subsystem.

Additional objects and advantages of the invention will become apparent to the skilled in the art upon reference to the detailed description taken in conjunction with the provided figures.

### BRIEF DESCRIPTION OF THE DRAWINGS

FIG. 1 is an image of an exemplary prescription label generated by a pharmacy management computer system.

FIG. 2 is a functional block diagram of a pharmacy tablet dispensing system in accordance with the present invention, including an interface unit operably coupled between a pharmacy management computing subsystem and tablet counting/dispensing subsystem.

FIGS. 3A and 3B are flow charts illustrating operations of the interface unit of FIG. 1 that extract relevant information from a prescription label represented by a print command file that is generated by the pharmacy management computing subsystem, and supplies such information to the tablet counting/dispensing subsystem.

FIG. 4A is a flow chart illustrating operations carried out as part of a setup routine performed by the end user such that the interface unit captures relevant information for the specific label format utilized by the pharmacy management computer subsystem.

FIG. 4B is an image of a display screen that shows a bounding box overlaid in a specific portion of a sample label bit map image; the location of the bounding box provides the location of the corresponding data field in subsequent label processing operations.

FIG. 4C is a flow chart illustrating operations carried out as part of a set up routine performed by the end user such that the interface unit automatically generates a bar code symbol derived from a user-specified data field, and adds the automatically-generated bar code symbol to a user-specified part of the prescription label.

FIG. 5 illustrates a functional block diagram of an exemplary system architecture of the interface unit 10 of FIG. 2.

FIG. 6 is a functional block diagram of an alternate embodiment of the pharmacy tablet dispensing system in accordance with the present invention, including a KVM switch that enables the pharmacy management subsystem and the interface unit to share a common display, mouse, and keyboard.

FIGS. 7A and 7B illustrate a flow chart of an improved table dispensing verification process in accordance with the present invention.

### DETAILED DESCRIPTION OF THE PREFERRED EMBODIMENTS

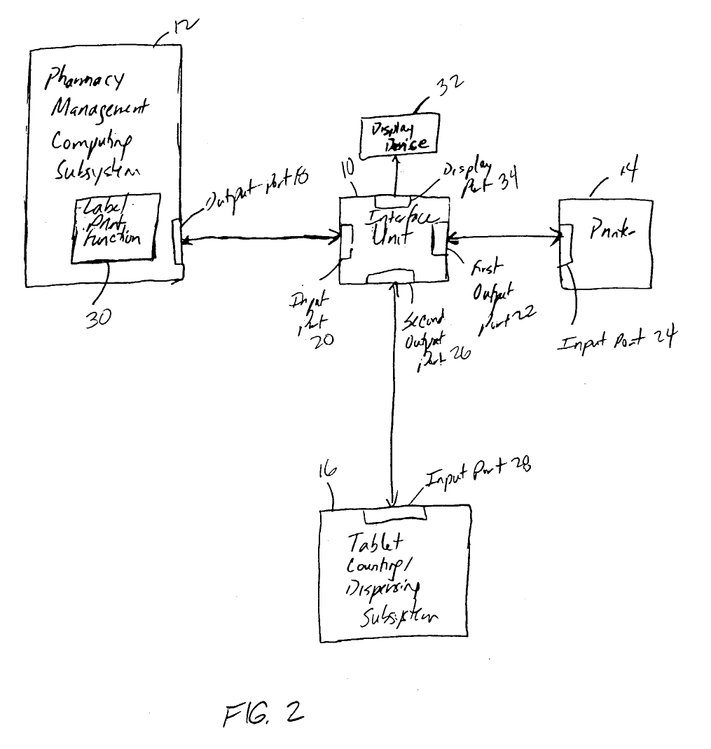

Turning now to FIG. 2, according to a preferred embodiment of the invention, an interface unit 10 is operably coupled between a pharmacy management computing subsystem 12 and a printer 14. In addition, the interface unit 10 is operably coupled between the pharmacy management computing subsystem 12 and a tablet counting/dispensing subsystem 16. More specifically, an output port 18 of the pharmacy management computing subsystem 12 is coupled to an input port 20 of interface unit 10, a first output port 22 of interface unit 10 is coupled to an input port 24 of printer 14, and a second output port 26 is coupled to an input port 28 of the tablet counting/dispensing subsystem 16.

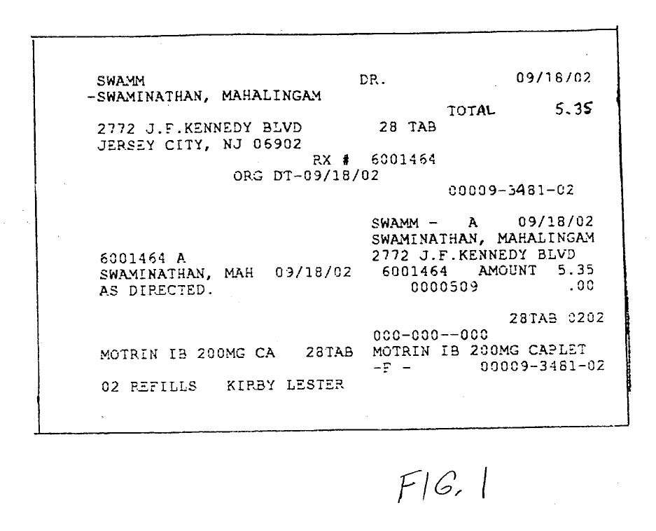

The pharmacy management computing subsystem 12 preferably maintains a database of information that generally includes customers, doctors and other health care providers, prescriptions to be filled, prescription that have been filled, etc. In addition, the pharmacy management computer subsystem 12 preferably includes features that enable efficient processing of prescriptions as described above. The pharmacy management computer subsystem 12 includes a label print function 30 that generates a printer command file in response to a user requesting that a given prescription label be printed. The prescription label is preferably organized as a two dimensional array of data fields that stores information including a patient name, prescription number, drug name and strength, quantity-to-be-dispensed, patient instructions, doctor name, price paid by patient, etc as illustrated in the exemplary prescription label shown in FIG. 1. In the United States, the drug name and strength is identified by a multi-digit code known as the National Drug Code (NDC) as described above. Equivalent codes are used in other countries.

The tablet counting/dispensing subsystem 16 assists the pharmacy in filling prescriptions. It may be realized as a preset tablet counter, a pour-through tablet counter, or a cassette feed tablet counter as described in previously incorporated U.S. patent application Ser. No. 09/871,532. Alternatively, the tablet counting/dispensing subsystem 16 may be a robotic-based subsystem that counts and dispenses tablets from prefilled cassettes into containers. In addition, the tablet counting/dispensing subsystem 16 may automatically print and apply the prescription label (and possibly other labels) on the container and deliver the container for final inspection. An exemplary robot-based automatic tablet dispensing system is described in detail in Williams et al., U.S. Pat. No. 6,036,812, previously incorporated by reference herein.

In accordance with the present invention, the printer command file generated by the label print function 30 of the pharmacy management computing subsystem 12 is supplied to the interface unit 10 (over the data communication link between output port 18 and input port 20). Interface unit 10 stores this printer command file and preferably forwards it to the printer 14 (over the data communication link between first output port 22 and the input port 24), where the prescription label is printed. In addition, the interface unit 10 processes the printer command file to render and store a bit map image of the prescription label, and performs symbol recognition operations on portions of the bit map image to generate a sequence of symbol identifier values (e.g., an alphanumeric character string) that corresponds to symbols identified in such portions. This sequence of symbol identifiers represents information pertaining to the prescription, such as NDC number, prescription number, drug name and strength, count (quantity-to-be-dispensed), patient instructions (SIG code), patient's name, price, etc. It is used to build a data message that is communicated to the tablet counting/dispensing subsystem 16 (over the data communication link between second output port 26 and input port 28). The tablet counting/dispensing subsystem 16 extracts and stores the data in this data message, and accesses this stored data to assist in tablet counting operations and/or tablet dispensing operations performed therein.

Advantageously, the interface unit 10 provides an external data communication interface between subsystems 12 and 16 that does not require access and knowledge of the internal structures of the subsystems 12 and 16. Moreover, the interface unit 10 is simple and efficient to set up, use and maintain, thereby providing decreased costs to the solutions provider and the pharmacy.

The data communication link between the output port 18 and the input port 20 may be a wired serial data link (e.g., RS-232 link), a wired parallel data link (e.g., an LPT link), a high speed wired serial data link (e.g., USB or Firewire data link), a wired network link (e.g., Ethernet link), or a wireless network link (e.g., 802.11(a), 802.11(b) or Bluetooth wireless link). Similarly, the data communication link between the first output port 22 and the input port 24 may be a wired serial data link (e.g., RS-232 link), a wired parallel data link (e.g., an LPT link), a high speed wired serial data link (e.g., USB or Firewire data link), a wired network link (e.g., Ethernet link), or a wireless network link (e.g., 802.11(a), 802.11(b) or Bluetooth wireless link). Finally, the data communication link between the second output port 22 and the input port 24 may be a wired serial data link (e.g., RS-232 link), a wired parallel data link (e.g., an LPT link), a high speed wired serial data link (e.g., USB or Firewire data link), a wired network link (e.g., Ethernet link), or a wireless network link (e.g., 802.11(a), 802.11(b) or Bluetooth wireless link).

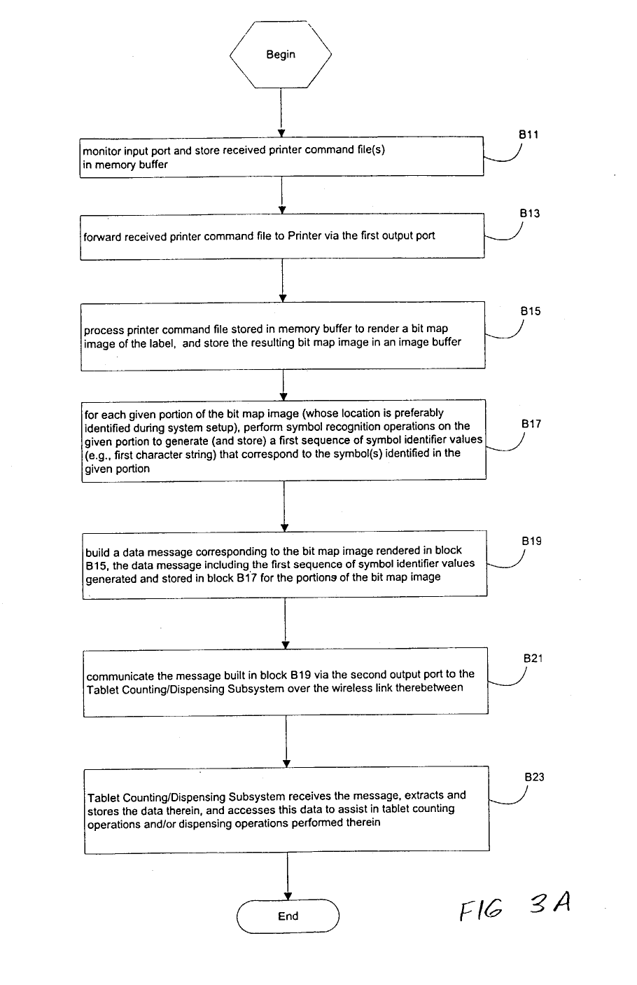

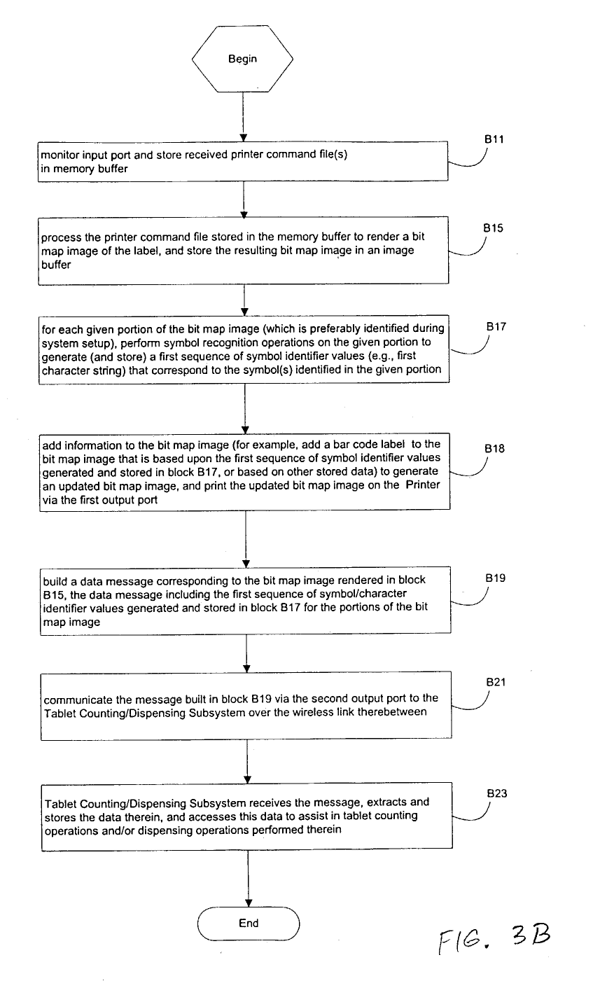

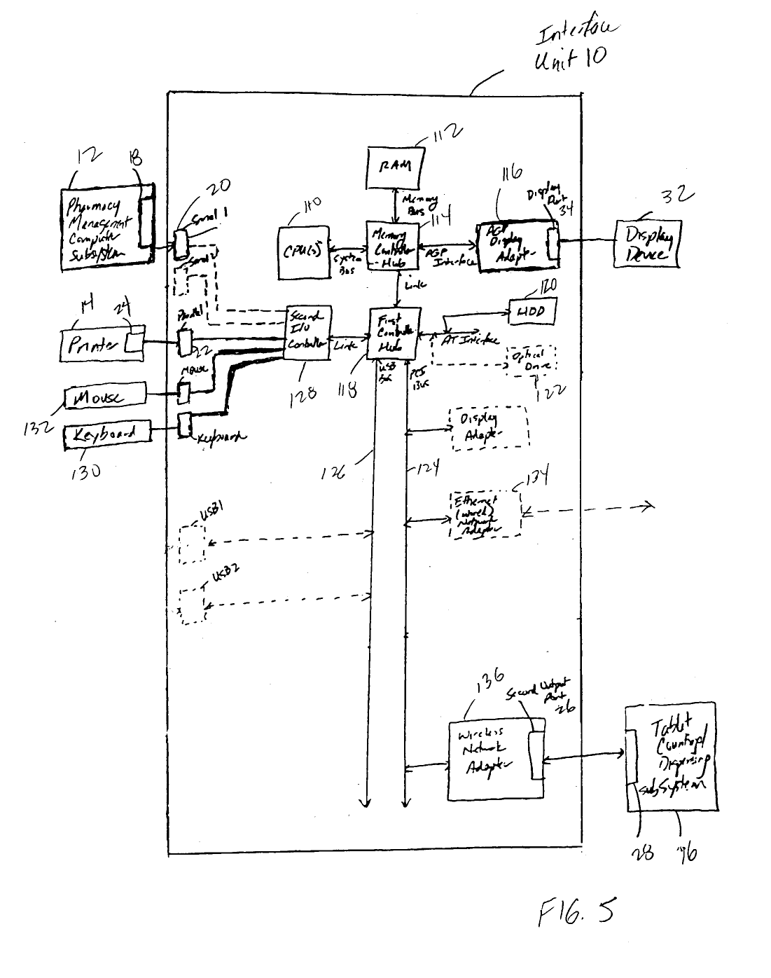

FIGS. 3A and 3B are flow charts illustrating the operations carried out by the interface unit 10 to provide an external data communication interface between subsystems 12 and 16. Preferably, such operations are realized as one or more routines that are stored in persistent memory (e.g., the hard disk drive of FIG. 5) and loaded into memory for execution by one or more general purpose microprocessors (e.g., the CPU(s) of FIG. 5). It is assumed that the label print function 30 of the management subsystem 12 generates a printer command file in response to a user requesting that a given prescription label be printed, and supplies the printer command file to the unit 10 over the data communication link between the output port 18 and the input port 24. In the preferred embodiment of the present invention, the printer command file for the prescription label comprises a series of operators that conform to a page description language, such as the Postscript language or PCL language. Alternatively, the printer command file may comprise raw pixel values that represent a bitmap image of the prescription label.

The operations of FIG. 3A begin in block B11 whereby the input port 20 is monitored and the printer command file supplied thereto is received and stored in a memory buffer.

In block B13, the printer command file may be forwarded to the printer 14 over the data communication link between the first output port 22 and the input port 24. The operation of block B13 is optional and thus may be omitted.

In block B15, the printer command file stored in the memory buffer in block B11 is processed to render a bit map image of the prescription label. The resulting bit map image is stored in an image buffer. In the event that the printer command file for the prescription label conforms to a page description language (such as the Postscript language or PCL language), a suitable interpreter may be utilized to perform such processing. There are many commercially-available interpreters for the Postscript language and PCL language, such as those available from Artifex Software Inc. of San Rafael, Calif.

In block B17, symbol recognition operations are performed for one or more portions of the bit map image stored in the image buffer to generate (and store) a first sequence of symbol identifier values (e.g., first character string) for symbol(s) identified in the portion of the bit map image. Such symbol recognition operations may include optical character recognition operations that detect and decode alpha-numeric characters in the portion and/or image-based bar code scanning operations that detect and decode bar code symbols in the portion. There are many vendors that provide suitable optical character recognition software, such as the Imaging SDK available from ScanSoft, Inc. of Peabody, Mass. Also, there are many vendors that provide suitable image-based bar code scanning operations, such as the SwiftDecoder software package available from Omniplanar, Inc. of Princeton, N.J.

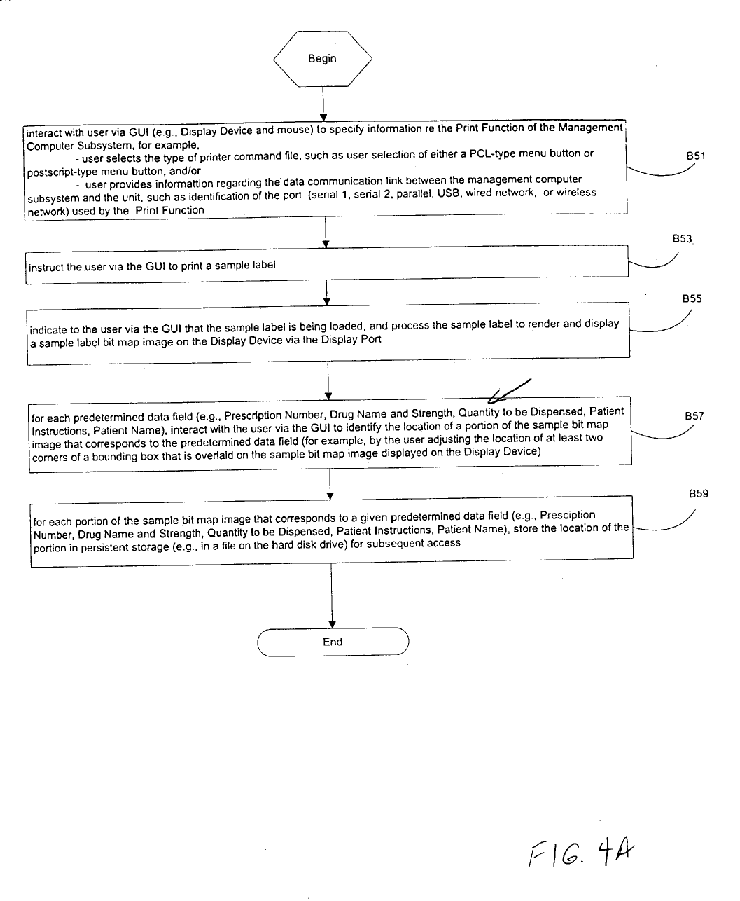

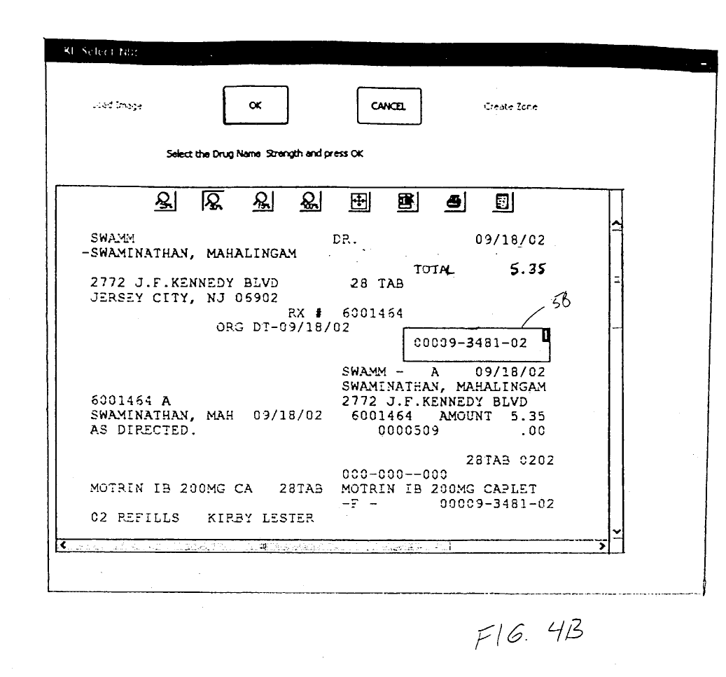

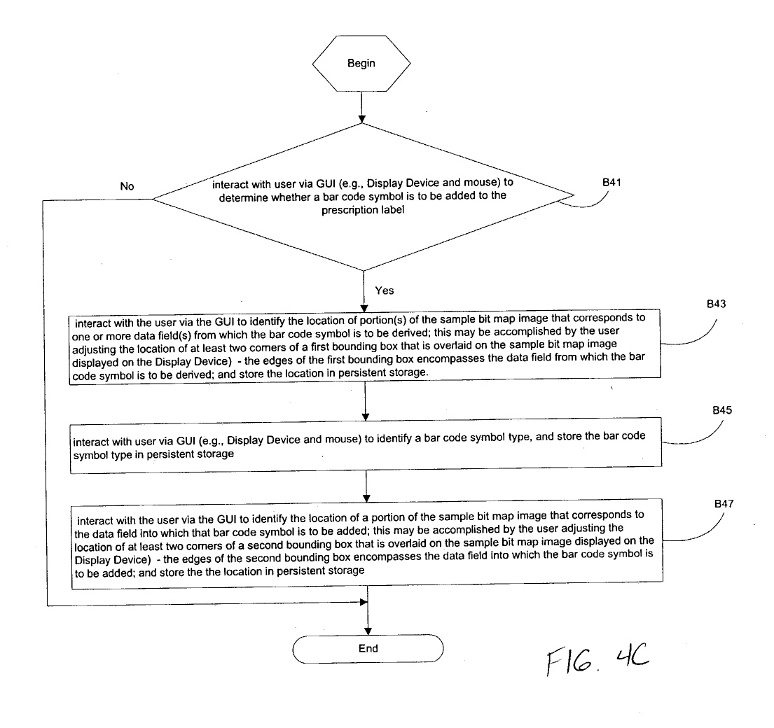

Preferably, the portions of the bit map image which are subject to symbol recognition operations in block B17 are determined via a setup routine that is described below with respect to FIGS. 4A and 4B. Alternatively, such portions can be identified during design, testing or setup by the manufacturer of unit 10, and fixed therein; although this option does not offer the flexibility of the approach of FIGS. 4A and 4B.

In block B19, the first sequence of symbol identifier values (e.g., first character string) generated and stored in block B17, and possibly other data, is added to a message that is to be communicated to the tablet counting/dispensing subsystem 16.

In block B21, the message built in block B19 is communicated to the tablet counting/dispensing subsystem 16 over the data communication link between the second output port 26 and the input port 28.

Finally, in block B23, the tablet counting/dispensing subsystem 16 receives the message, extracts and stores the data stored therein (including the first sequence of symbol identifier values), and subsequently accesses this data to assist in tablet counting operations and/or tablet dispensing operations performed therein. For example, drug name and strength information (e.g., derived from the NDC code) that is encoded in the character string of the message can be used by subsystem 16 to control a robot to select the appropriate container/cassette. Alternatively, it may used to verify that the pharmacist has manually selected the appropriate bulk container/cassette prior to performing automatic counting operations. Similarly, the quantity-to-be-dispensed information that is encoded in the character string of the message can be used by subsystem 16 to control an automatic tablet counter (or robot) to count/dispense the appropriate number of tablets.

The operations of FIG. 3B are similar to those of FIG. 3A, except that the operations of forwarding the printer command file to the printer in block B13 is replaced by the operations of block B18 whereby the bit map image of the label generated in block B15 is updated (for example, by adding information to the bit map image, by changing the font and/or layout of the bit map image, or by making other changes to the bit map image). The updated bit map image is then printed to generate a printer command file representing the updated bit map image. Alternatively, updates may be made to the printer command file stored in block B11 such that it represents an updated prescription label (for example, by adding information to the prescription label, by changing the font and/or layout of the prescription label, or by making other changes to the prescription label). In either case, the printer command file representing the updated prescription label is output to the printer 14 via the data communication link between the first output port 22 and input port 24. The updated bit map image (or the printer command file representing the updated prescription label) may be output to the tablet counting/dispensing subsystem 16 via the data communication link between the second output port 26 and the input port 28.

The changes to the bit map image (or changes to the printer command file representing the prescription label) provided in block B18 may include the addition of a bar code symbol representing the first sequence of symbol identifier values (e.g., first character string) generated and stored in block B17. The generation of a bar code symbol bit map corresponding to a character string may be provided by many commercially-available software vendors, including DLSoft of Essex, United Kingdom and IDAutomation.com, Inc. of Tampa, Fla. The changes to the bit map image (or changes to the printer command file representing the prescription label) provided in block B18 may also include the addition of data stored by the interface unit 10 or other data. In addition, the updated bit map image (or changes to the printer command file representing the prescription label) provided in block B18 may be made by changing the font and/or layout of the bit map image, or by making other changes to the bit map image. In addition, the operations of block B18 (or part(s) of such operations) may be performed at a point subsequent to block B11 (for example, between the operations of blocks B19 and B21).

The location of data fields in the prescription label and the corresponding bit map portions that are processed in block B17 varies over the pharmacy management computer subsystems that are generally used in pharmacies today. In order to support such varying label formats, one option is customize the operations of the interface unit 10 for each vendor. This option is costly to implement and maintain.

FIG. 4A is a flow chart illustrating exemplary operations that enable the end-user pharmacist to set up the interface unit 10 to support the specific label format utilized by the pharmacy management computer subsystem installed in the pharmacy, and thus provide the data communication interface between subsystems 12 and 16 in accordance with FIGS. 2, 3A and 3B as described above. The setup operations utilize a graphical user interface (GUI), which includes, for example, a display device 32 operably coupled to a display port 34 of the interface unit 10 and a pointing device (not shown) operably coupled to the unit 10 as shown in FIG. 1.

The operations begin in block B51 whereby the user interacts via the GUI to specify information regarding the print function 30 of management subsystem 12. For example, such operations may include the user selecting the type of printer command file (e.g., postscript-type or PCL-type) from a menu, and/or the user providing information regarding the data communication link between the management subsystem 12 and the unit 10, e.g., by identifying the link from a menu (serial 1, serial 2, parallel, USB, wired network link, wireless network link).

In block B53, the user is instructed via the GUI to print a sample label, and in block B55 the user is provided an indication that the sample label is being loaded. Also in block B55, the sample label is processed to render and display a sample label bit map image on the display device 32 via the display port 34.

In block B57, for each one of a number of predetermined data fields in the sample label (such as NDC number, prescription number, drug name and strength, count (quantity-to-be-dispensed), patient instructions (SIG code), patient's name, price, etc), the user interacts with the GUI to identify a location of a portion of the sample label bit map image that corresponds to the predetermined data field. Such operations are preferably accomplished by the user adjusting the location of at least two corners of a bounding box that is overlaid on the sample label bit map image displayed on the display device 32. For example, FIG. 4B shows a bounding box 58 that is overlaid by the user to encompass an NDC code data field that identifies the drug name and strength. The location of the bounding box 58 is adjusted by the mouse click and drag operations that specify the location of at least two corners of the bounding box 58. Preferably, such operations are repeated for multiple data fields in the sample label (such as NDC number, prescription number, drug name and strength, count (quantity-to-be-dispensed), patient instructions (SIG code), patient's name, price, etc).

In block B59, for each one of the predetermined data fields in the sample label (such as NDC number, prescription number, drug name and strength, count (quantity-to-be-dispensed), patient instructions (SIG code), patient's name, price, etc), the location the corresponding portion of the sample bit map image identified in block B57 is stored in persistent storage (e.g., on a hard disk drive) for subsequent access during block B17 of FIG. 3A or 3B.

Advantageously, the setup operations of blocks B51-B59 provide for flexible mapping of the data fields of the label to the symbol recognition operations of block B17 such that the unit predetermined data field. Such operations are preferably accomplished by the user adjusting the location of at least two corners of a bounding box that is overlaid on the sample label bit map image displayed on the display device 32. For example, FIG. 4B shows a bounding box 58 that is overlaid by the user to encompass an NDC code data field that identifies the drug name and strength. The location of the bounding box 58 is adjusted by the mouse click and drag operations that specify the location of at least two corners of the bounding box 58. Preferably, such operations are repeated for multiple data fields in the sample label (such as NDC number, prescription number, drug name and strength, count (quantity-to-be-dispensed), patient instructions (SIG code), patient's name, price, etc).

In block B59, for each one of the predetermined data fields in the sample label (such as NDC number, prescription number, drug name and strength, count (quantity-to-be-dispensed), patient instructions (SIG code), patient's name, price, etc), the location the corresponding portion of the sample bit map image identified in block B57 is stored in persistent storage (e.g., on a hard disk drive) for subsequent access during block B17 of FIG. 3A or 3B.

Advantageously, the setup operations of blocks B51-B59 provide for flexible mapping of the data fields of the label to the symbol recognition operations of block B17 such that the unit 10 can be quickly and efficiently adapted to operate over a broad range of label formats utilized by various pharmacy management subsystems 12.

In an alternate embodiment of the present invention, the operations of FIG. 4A can include additional operations that set up the automatic addition of a bar code symbol to the label in accordance with the label processing performed by the interface unit 10 as described above with respect to FIG. 3B. An example of such set up operations is shown in the flow chart of FIG. 4C. These operations begin in block B41 whereby the user interacts via the GUI to indicate whether a bar code symbol is to be added to the prescription label. If so, the operation continues to block B43; otherwise, the operations end.

In block B43, the user interacts with the GUI to identify a location of a portion of the sample bit map image that corresponds to one or more data fields from which the bar code symbol is to be derived. Such operations are preferably accomplished by the user adjusting the location of at least two corners of a bounding box that is overlaid on the sample label bit map image displayed on the display device 32. The edges of the bounding box (an exemplary bounding box is shown in FIG. 4B) encompasses the data field into which the bar code symbol is to be added. The location of the bit map image identified in block B43 is stored in persistent storage (e.g., on a hard disk drive) for subsequent access during block B18 of FIG. 3B. Note that some (or all) of the operations of block B43 may be performed as part of blocks B57 and B59 of FIG. 4A. In this case, some (or all) of the operations of block B43 may be omitted.

In block B45, the user interacts via the GUI to identify the type of bar code symbol to be generated. The bar code symbol type (e.g., UPC, code 39, code 128, PDF417) is preferably selected from a menu or other similar means. The bar code symbol type is stored in persistent storage for subsequent access during block B18 of FIG. 3B.

In block B47, the user interacts with the GUI to identify a location of a portion of the sample label bit map image that corresponds to the data field into which the bar code symbol is to be added. Such operations are preferably accomplished by the user adjusting the location of at least two corners of a bounding box that is overlaid on the sample label bit map image displayed on the display device 32. The edges of the bounding box (an exemplary bounding box is shown in FIG. 4B) encompasses the data field into which the bar 25 code symbol is to be added. The location of the bit map image identified in block B47 is stored in persistent storage for subsequent access during block B18 of FIG. 3B.

The data generated and stored during the set up operations of FIG. 4C are used during the label processing operations of FIG. 3B to provide for the automatic addition of a bar code symbol to the prescription label. More specifically, during the label processing operations of FIG. 3B, the user-specified location of the bit map image portion from which the bar code symbol is to be derived is accessed from storage, and the corresponding bit map image portion is subject to automatic symbol recognition operations that generate a sequence of symbol identifier values (e.g., character string) for symbol(s) identified in the corresponding bit map image portion. Such symbol recognition operations may include optical character recognition operations that detect and decode alpha-numeric characters in the portion and/or image-based bar code scanning operations that detect and decode bar code symbols in the portion. In addition, the user specified bar code symbol type stored in block B45 is used to automatically generate a bar code symbol of a particular type that corresponds to the sequence of symbol identifiers extracted from the bit map image portion. Finally, the automatically-generated bar code symbol is added to the corresponding bit map image portion at the user-specified location stored in block B47.

Advantageously, the set up operations of blocks B41-B47 provide for flexible mapping of data field(s) of the prescription label to the automatic bar code symbol generation operations and the label update operations (which automatically add the generated bar code symbol to the prescription label) of FIG. 3B such that the interface unit 10 can be quickly and efficiently adapted to operate over a broad range of label formats and bar code symbol formats utilized by various pharmacy management subsystems 12.

FIG. 5 illustrates a functional block diagram of an exemplary system architecture of the interface unit 10 of FIG. 2. It includes one or more CPU(s) 110 coupled to random access memory 112 (RAM) via a memory controller hub 114. In addition, the memory controller hub 114 preferably supports an advanced graphics port (AGP) interface to an AGP display adapter 116, which may be used to drive the display device 41 as shown. Alternately, a display adapter may be coupled to the PCI bus as shown and used to drive the display device 32. A first controller hub 118 is coupled to the memory controller hub 114 and supports an interface to a hard disk drive 120 (HDD) and possibly an optical drive 122 (e.g., CD-ROM drive, CDRW drive or DVD-ROM drive). In addition, the first controller hub 118 supports a PCI bus 124 and a USB bus 126. A second I/O controller 128 is coupled to the first controller hub 118 and supports a plurality of serial ports (serial 1, serial 2), a parallel port (LPT port), and PS/2 keyboard and mouse ports as shown.

A PS/2 pointing device (such as a PS/2 mouse 130) and/or a PS/2 keyboard 132 may be coupled to the PS/2 keyboard and mouse ports, respectively, as shown. Alternatively, a USB pointing device (such as a USB mouse) and/or USB keyboard may be coupled to the USB bus 126 via the USB ports.

In addition, a wired network adapter 134 (e.g., Ethernet adapter) and/or one or more wireless network adapters 136 (e.g., 802.11(a), 802.22(b), Bluetooth adapter) may be coupled to the PCI bus as shown.

The pharmacy management computer subsystem 12 may be coupled to the unit 10 via a serial port as shown. Alternatively, the pharmacy management computer subsystem 12 may be coupled to the unit 10 via the parallel port, a USB port, the wired network adapter 134, or the wireless network adapter 136.

The printer 14 may be coupled to the interface unit 10 via the parallel port as shown. Alternatively, the printer 14 may be coupled to the unit via a serial port, a USB port, the wired network adapter 134, or the wireless network adapter 136.

In addition, the tablet counting/dispensing subsystem 16 may be coupled to the interface unit 10 via the wireless network adapter 136 as shown. Alternatively, the tablet counting/dispensing subsystem 16 may be coupled to the interface unit 10 via a serial port, the parallel port, a USB port, or the wired network adapter.

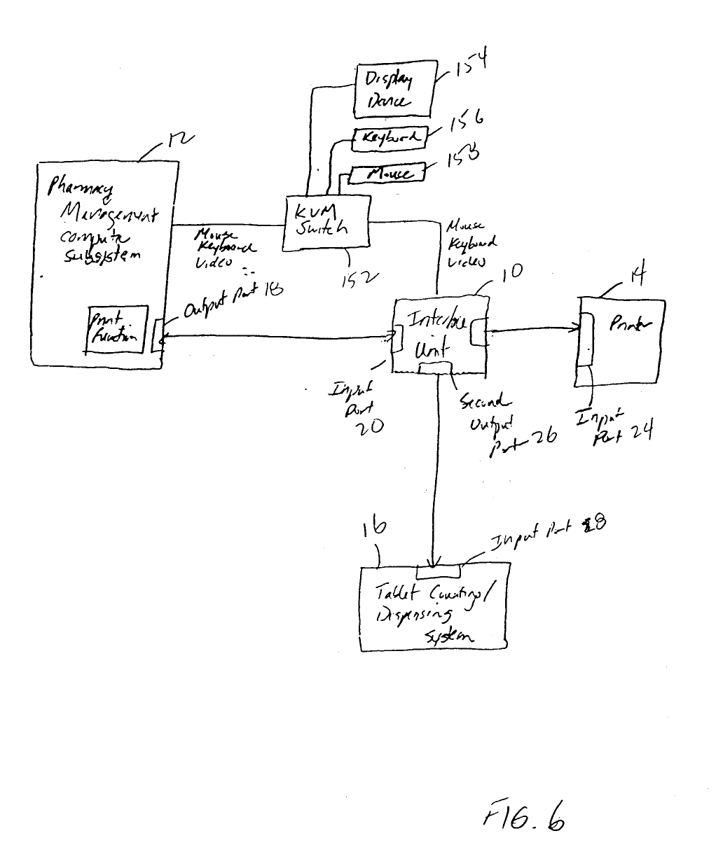

As shown in FIG. 6, the interface unit 10 of FIG. 1 may be may be configured with a keyboard video-mouse (KVM) switch such that the pharmacy management computer subsystem 12 and the interface unit 10 share a common display device 154, mouse 156 and keyboard 158 as shown in FIG. 6. The keyboard video and mouse signals are passed to one of the two subsystems (12 or 10) based upon user interaction with a button (or on screen display) on the KVM switch 152.

In another aspect of the present invention, an improved verification process is provided. Verification is an important step that is used in many modern pharmacies. Generally, verification occurs before tablets are counted and dispensed, and involves scanning the bar code symbol on the prescription label to be filled, and scanning the bar code symbol on the bulk container from which the tablets are to be dispensed. If the two bar code symbols match, the user is notified that the verification was successful; otherwise the user is notified that the verification is unsuccessful and the counting/dispensing operations are aborted.

It has been observed by the inventor of the present invention that the content and arrangement of the information embedded in the bar code symbols contained in labels generated by many commercially-available pharmacy management computer subsystems varies over these systems. For example, the prescription labels generated by one vendor include a bar code symbol encoding the quantity-to-be-dispensed followed by the NDC code, while the labels generated by another vendor include a bar code symbol that includes the NDC code followed by the quantity-to-be-dispensed. Such variations in the content and arrangement of information in the bar code symbols makes the verification process difficult because it must customized for each vendor.

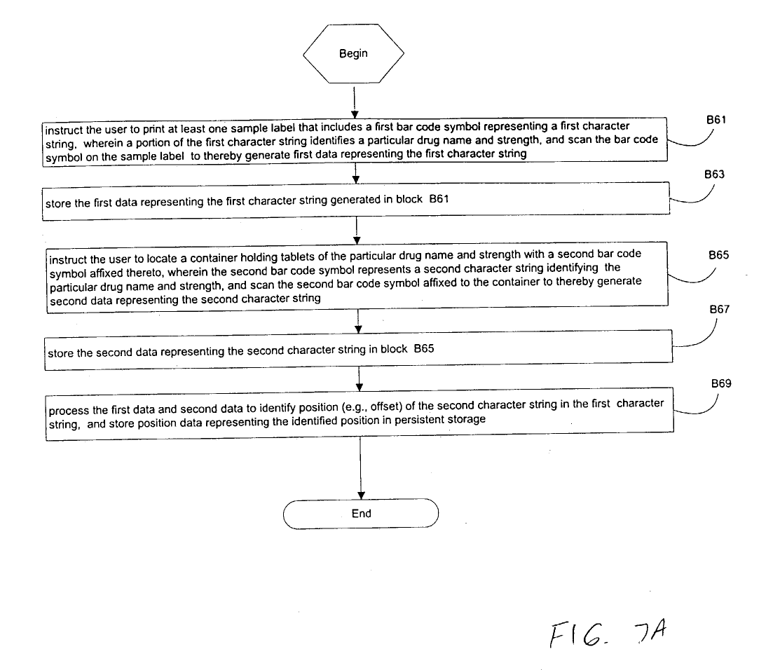

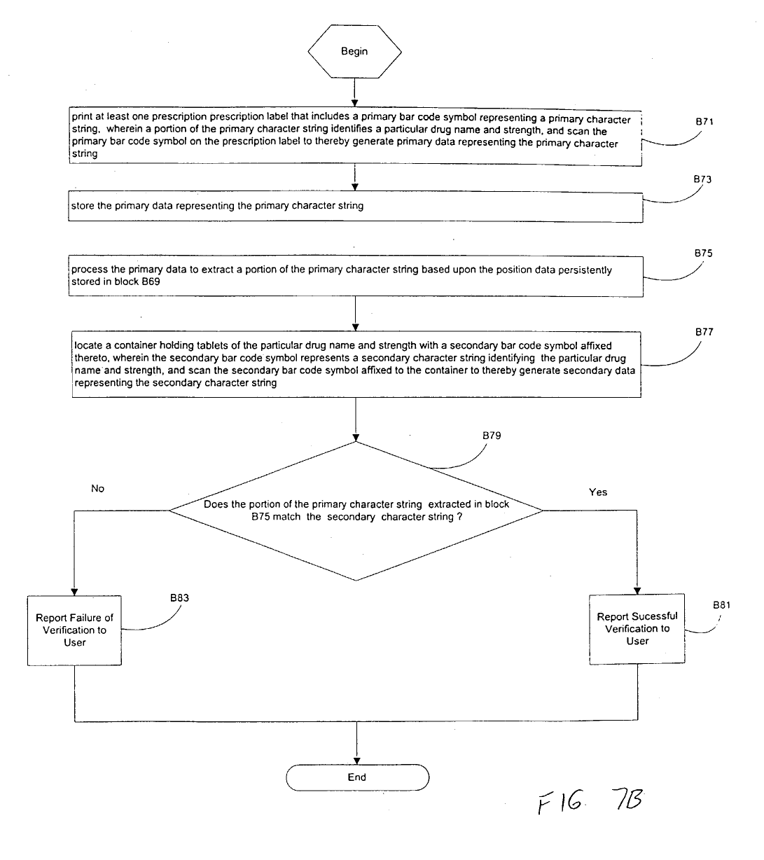

FIGS. 7A and 7B illustrate the improved verification process in accordance with the present invention. Such methodology includes a setup routine (FIG. 7A) that enables the end-user pharmacist to customize the verification process (FIG. 7B) for the particular prescription label format (and bar code symbol format included therein) that is utilized by the pharmacy management computer subsystem. The methodology is preferably carried out in conjunction with the automatic counting operations performed by an automatic tablet counter that includes a GUI and a bar code scanner operably coupled thereto.

The setup routine of FIG. 7A begins in block B61 wherein the user is instructed via the GUI to print at least one sample label that includes a first bar code symbol pertaining to a particular drug name and strength. This first bar code symbol represents a first character string, and a portion of this first character string identifies the particular drug name and strength (e.g., particular NDC code). In addition, the user is instructed to scan the first bar code symbol on the sample label with the bar code symbol scanner to thereby generate first data representing the first character string. In block B63, the first data generated in block B61 is stored in memory.

In block B65, the user is instructed via the GUI to locate a bulk container holding tablets of the same particular drug name and strength (e.g., identified by the same particular NDC code). The container includes a second bar code symbol affixed thereto. This second bar code symbol represents a second character string that identifies the same particular drug name and strength. The user is then instructed to scan the second bar code symbol with the bar code symbol scanner to thereby generate second data representing the second character string.

In block B67, the second data generated in block B65 is stored in memory.

Finally, in block B69, the first and second data are processed to identify position of the second character string in the first character string. Preferably, such position is represented by an offset value from the first character of the second character string. Such position data is then stored in persistent storage and the setup process ends.

As shown in FIG. 7B, the verification process begins in block B71 whereby at least one prescription label is printed. This prescription label follows the same format as the sample label printed and processed in block B61. Thus, the prescription label includes a primary bar code symbol (whose format is the same as the format of the first bar code symbol in block B61). This primary bar code symbol represents a primary character string, and a portion of this primary character string identifies a particular drug name and strength (e.g., particular NDC code). This particular drug name and strength may (or may not) be the same as the drug name and strength in block B61. The primary bar code symbol is then scanned with the bar code symbol scanner to thereby generate primary data representing the primary character string.

In block B73, the primary data generated in block B71 is stored in memory. In block B75, the primary data is processed to extract a portion of the primary character string that corresponds to the position data generated and stored in block B69 of the setup routine. For example, in the exemplary case where the position is identified by an offset value as described above, this offset value is used as the location of starting character of the extracted portion.

In block B77, a bulk container holding tablets of the same particular drug name and strength (e.g., identified by the same particular NDC code as block B71) is located. The container includes a secondary bar code symbol affixed thereto (which is analogous to the second bar code symbol in block B65). This secondary bar code symbol represents a secondary character string that identifies the same particular drug name and strength. The secondary bar code symbol is then scanned with the bar code symbol scanner to thereby generate secondary data representing the secondary character string.

In block B79, the primary data and secondary data are processed to determine whether the portion of the primary character string (which is extracted in block B75) matches the secondary character string. If so, the operation continues to block B81 to report successful verification to the user; otherwise, the operation continues to block B83 to report failure of the verification process to the user.

Advantageously, the set up and verification methodology of FIGS. 7A and 7B enable the end-user pharmacist to efficiently customize the verification process for the particular prescription label format (and bar code symbol format included therein), and thus provide for decreased costs to the solutions provider and the pharmacy.

There have been described and illustrated herein embodiments that provide an efficient and easy to use data communication interface between a pharmacy management computer subsystem and an automatic counting/dispensing subsystem. While particular embodiments of the invention have been described, it is not intended that the invention be limited thereto, as it is intended that the invention be as broad in scope as the art will allow and the specification be read likewise. Thus, while the interface mechanism has been described as being located external to the pharmacy management computer subsystem and external to the automatic counting/dispensing subsystem, it will be appreciated that portions of the interface mechanism may be integrated into the pharmacy management computer subsystem and/or the automatic counting/dispensing subsystem. It will therefore be appreciated by those skilled in the art that yet other modifications could be made to the provided invention without deviating from its spirit and scope as so claimed.

What is claimed is:

1. In a system including a first subsystem that generates a label and a printer command file including data that represents said label, and a second subsystem that automatically counts and/or dispenses tablets, a method for automatic capture of information contained in said label and for automatic supply of said information to said second subsystem, the method comprising:
a) providing a unit operably coupled between said first and second subsystems;
b) supplying said printer command file to said unit;
c) upon receipt of said printer command file, controlling said unit to process said printer command file to render a bit map image of said label and store said bit map image in an image buffer;
d) for at least one given portion of said bit map image stored in said image buffer, controlling said unit to perform symbol recognition operations on said given portion to generate a first sequence of symbol identifier values that correspond to symbols identified in said given portion;
e) controlling said unit to build a message based upon said first sequence of symbol identifier values; and
f) communicating said message to said second subsystem for use in tablet counting operations and/or dispensing operations performed therein.

2. A method according to claim 1, further comprising:
g) controlling said unit to forward said printer command file to a printer that processes said command file to print said label.

3. A method according to claim 1, wherein:
the communicating operations of element f) occur over a wireless communication link between said unit and said second subsystem.

4. A method according to claim 1, wherein:
said message includes said first sequence of symbol identifiers, and wherein said second subsystem receives said message, extracts and stores said first sequence of symbol identifiers in said message, and accesses the stored first sequence of symbol identifiers to assist in tablet counting tablet counting operations and/or dispensing operations performed by said second subsystem.

5. A method according to claim 1, wherein:
said given portion of said bit map image stored in said image buffer corresponds to a data field storing a sequence of symbols that represent one of the following
i) prescription number,
ii) national drug code,
iii) numeric code identifying drug name and strength,
iv) quantity-to-be-dispensed,
v) patient instructions, and
vi) patient name.

6. A method according to claim 1, wherein:
said data of said printer command file comprises a series of operators that conform to a page description language.

7. A method according to claim 6, wherein:
said page description language comprises one of the Postscript language and the PCL language.

8. A method according to claim 1, further comprising:
g) coupling said first subsystem to said unit over a data communication link selected from the following
i) a wired serial data link;
ii) a wired parallel data link;
iii) a USB data link;
iv) a wired network link; and
v) a wireless network link.

9. A method according to claim 2, further comprising:
g) coupling said unit to said printer over a data communication link selected from the following
i) a wired serial data link;
ii) a wired parallel data link;
iii) a USB data link;
iv) a wired network link; and
v) a wireless network link.

10. A method according to claim 1, further comprising:
g) providing a display device operably coupled to said unit; and
h) performing the following setup operations
i) interacting with a user via said display device to instruct said user to print a sample label, wherein data fields of said sample label correspond to data fields of said label,
ii) supplying a second printer command file that includes data representing said sample label to said unit,
iii) upon receipt of said second printer command file, processing said second printer command file to generate and display a sample label bit map image on said display device,
iv) for at least one data field in said sample label, interacting with said user via said display device to identify a location of a portion of said sample bit map image that corresponds to said at least one data field, and
v) storing said location in persistent storage for subsequent access.

11. A method according to claim 10, wherein:
said location stored in persistent storage is used by element d) to identify said given portion of said bit map image stored in said image buffer.

12. A method according to claim 11, wherein:
said at least one data field stores a sequence of symbols that represent one of the following
i) prescription number,
ii) national drug code,
iii) numeric code identifying drug name and strength,
iv) quantity-to-be-dispensed,
v) patient instructions, and
vi) patient name.

13. In a system including a first subsystem that generates a label and a printer command file including data that represents said label, and a second subsystem that automatically counts and/or dispenses tablets, an apparatus that provides automatic capture of information contained in said label and automatic supply of said information to said second subsystem, the apparatus comprising:
a) a first port operably coupled to said first subsystem;
b) a second port operably coupled to said second subsystem;
c) at least one programmed microprocessor that performs the following operations
i) upon receipt of said printer command file, processing said printer command file to render a bit map image of said label and storing said bit map image in an image buffer,
ii) for at least one given portion of said bit map image stored in said image buffer, performing symbol recognition operations on said given portion to generate a first sequence of symbol identifier values that correspond to symbols identified in said given portion, and
iii) building a message that is based upon said first sequence of symbol identifier values for communication to said second subsystem for use in tablet counting operations and/or dispensing operations performed therein.

14. An apparatus according to claim 13, further comprising:
d) communication means for communicating said message to said second subsystem.

15. An apparatus according to claim 14, wherein:
said communication means comprises a wireless communication link between said unit and said second subsystem.

16. An apparatus according to claim 13, further comprising:
d) means for forwarding said printer command file to a printer that processes said command file to print said label.

17. An apparatus according to claim 13, wherein:
said message includes said first sequence of symbol identifiers, and wherein said second subsystem receives said message, extracts and stores said first sequence of symbol identifiers in said message, and accesses the stored first sequence of symbol identifiers to assist in tablet counting tablet counting operations and/or dispensing operations performed by said second subsystem.

18. An apparatus according to claim 13, wherein:
said given portion of said bit map image stored in said image buffer corresponds to a data field storing a sequence of symbols that represent one of the following
i) prescription number,
ii) national drug code,
iii) numeric code identifying drug name and strength,
iv) quantity-to-be-dispensed,
v) patient instructions, and
vi) patient name.

19. An apparatus according to claim 13, wherein:
said data of said printer command file comprises a series of operators that conform to a page description language.

20. An apparatus according to claim 19, wherein:
said page description language comprises one of the Postscript language and the PCL language.

21. An apparatus according to claim 13, further comprising:
d) means for coupling said apparatus to said first subsystem over a data communication link selected from the following
i) a wired serial data link;
ii) a wired parallel data link;
iii) a USB data link;
iv) a wired network link; and
v) a wireless network link.

22. An apparatus according to claim 21, wherein:
the element d) comprises a data communication link selected from the following
i) a wired serial data link;
ii) a wired parallel data link;
iii) a USB data link;
iv) a wired network link; and
v) a wireless network link.

23. An apparatus according to claim 13, further comprising:
d) a display adapter operably coupled to a display device; and
wherein said at least one programmed microprocessor performs a setup routine that includes the following operations
i) interacting with a user via said display device to instruct said user to print a sample label, wherein data fields of said sample label correspond to data fields of said label,
ii) upon receipt of a second printer command file that includes data representing said sample label, processing said second printer command file to generate and display a sample label bit map image on said display device,
iii) for at least one data field in said sample label, interacting with said user to identify a location of a portion of said sample bit map image that corresponds to said at least one data field, and
iv) storing said location in persistent storage for subsequent access.

24. An apparatus according to claim 23, wherein:
said location stored in persistent storage is used to identify said given portion of said bit map image stored in said image buffer.

25. An apparatus according to claim 23, wherein:
said operations of interacting with said user to identify a location of said portion of said sample bit map image that corresponds to said at least one data field includes interacting with said user to place a bounding box that is overlaid on said sample bit map image and that is sized by said user to encompass said portion, and wherein said location comprises pixel coordinates of at least two corners of said bounding box.

26. An apparatus according to claim 13, wherein:
said at least one data field stores a sequence of symbols that represent one of the following
i) prescription number,
ii) national drug code,
iii) numeric code identifying drug name and strength,
iv) quantity-to-be-dispensed,
v) patient instructions, and
vi) patient name.

27. An apparatus according to claim 13, further comprising:
a KVM switch that selectively couples a common display device, mouse, and keyboard to said apparatus and said first subsystem.

28. A method for automatic verification of drugs to be dispensed in accordance with a prescription, the method comprising:
a) during a setup routine associated with a particular drug name and strength,
performing a first scanning operation wherein a user scans a first bar code symbol on a sample prescription label for said particular drug name and strength, said first bar code symbol representing a first character string having a first portion that identifies said particular drug name and strength,
performing a second scanning operation wherein said user scans a second bar code symbol on a container holding tablets of said particular drug name and strength, said second bar code symbol representing a second character string that identifies said particular drug name and strength, and
processing data resulting from said first and second scanning operations to identify a position of said second character string in said first character string, and storing position data that represents said position in persistent storage; and
b) during at least one prescription verification routine associated with said particular drug name and strength,
performing a third scanning operation wherein a user scans a third bar code symbol on a prescription label for said particular drug name and strength,
processing results of said third scanning operation to extract data representing a portion of said third bar code symbol, wherein location of said portion is based upon said position data persistently stored during said setup routine, and
performing a fourth scanning operation wherein said user scans a fourth bar code symbol on a container holding tablets of said particular drug name and strength, said fourth bar code symbol representing a fourth character string that identifies said particular drug name and strength, and
processing said data representing a portion of said third bar code symbol and data resulting from said fourth scanning operation to make a determination whether character strings represented by said data match, and reporting a verification outcome to a user based upon said determination.

29. A method for automatic verification of drugs to be dispense in accordance with claim 28, wherein:
said setup routine and said at least one prescription verification routine are repeated for a set of different drug name and strengths.
